(19) United States
(12) Patent Application Publication
(10) Pub. No.: US 2009/0051171 A1
(43) Pub. Date: Feb. 26, 2009

(54) SLIDE LOCKING DEVICE

(75) Inventor: Koichi Yamamuro, Kanagawa (JP)

Correspondence Address: LOWE HAUPTMAN HAM & BERNER, LLP, 1700 DIAGONAL ROAD, SUITE 300, ALEXANDRIA, VA, 22314, US

(73) Assignee: NHK Spring Co., Ltd., Kanagawa (JP)

(21) Appl. No.: 11/815,433

(22) PCT Filed: Jan. 30, 2006
(86) PCT No.: PCT/JP2006/301491

§ 371 Date: Aug. 2, 2007

(30) Foreign Application Priority Data
Feb. 2, 2005 (JP) 2005-027098

(51) Int. Cl. E05F 1/10

(52) U.S. Cl. 292/163

(57) ABSTRACT

This slide locking device is incorporated in a opening-assistance device, so as to smoothly lock and unlock a reciprocating part so that it can move in opposite directions. The device includes a reciprocating part 21 that can move forward and backward in the device's longitudinal direction, locking parts 101 that can be engaged with or disengaged from the reciprocating part 21, and that lock the movement of the reciprocating part 21 when engaged with the reciprocating part 21, a first elastic part 24 that applies force to the locking parts 101 so as to move the locking parts 101 in the direction that disengages them from the reciprocating part 21, a second elastic part 29 that applies force to the locking parts 101 so as to move the locking parts 101 in the direction that engages them with the reciprocating part 21, and holding means 102 that hold the first elastic part 24 in a condition for storing an elastic force that is larger than the maximum elastic force of the second elastic part 29, and that prevent the elastic force of the first elastic part 24 from acting against the second elastic part 29 when the second elastic part 29 moves the locking parts 101 in the direction that engages them with the reciprocating part 21.

### CROSS-REFERENCE TO RELATED APPLICATIONS

The present Application is based on International Application No. PCT/JP2006/301491 filed on Jan. 30, 2006, which in turn corresponds to Japan Application No. 2005-027098 filed on Feb. 2, 2005 and priority is hereby claimed under 35 USC § 119 based on these applications. Each of these applications are hereby incorporated by reference in their entirety into the present application.

### FIELD OF THE INVENTION

The present invention relates to a slide locking device for locking and unlocking the movement—in the longitudinal direction—of a reciprocating part on, for instance, a door-opening-assistance device.

### BACKGROUND OF THE INVENTION

A slide locking device is incorporated, for example, in a door-opening-assistance device that assists a person by giving additional force in the door-opening direction in opening a door. The door-opening-assistance device is mounted to a door closer that automatically closes the door, so as to reduce the amount of force needed to be applied by a person in order to open the door.

A door-opening-assistance device consists of (1) a shaft part that is connected to a rotary shaft part of the door closer and rotates, (2) a slider that meshes with the shaft part and moves forward and backward, (3) a spring that stores the door-opening force that results due to the movement of the slider, (4) a locking mechanism that locks the spring into a condition so that the spring stores the door-opening force, and (5) an unlocking mechanism that releases the lock of the lock mechanism when the door is closed. When the door is completely closed, the spring force applies force, via the slider, to facilitate movement of the door in the door-opening direction, so that the door can be opened by a small force despite the door closer's energizing force in the closing direction, and so that the force that a person needs to exert to open the door is reduced.

Patent Document 1: Japanese Patent Application Laid-Open No. 2004-143812

The above-mentioned door-opening-assistance device requires both locking by a locking mechanism and release of the locking in response to the opening and closing of the door. Also, that device lacks smoothness in locking and unlocking, and also does not have a simple and compact structure for locking and unlocking.

### SUMMARY OF THE INVENTION

The present invention has been made to respond to the above-mentioned shortcomings, and one objective of the present invention is to provide—by incorporating the slide locking device in a device such as a door-opening-assistance device—a slide locking device that has a simple structure and that is capable of moving in the device's longitudinal direction and locking the movement of the slide.

In one aspect of the invention a slide locking device includes a reciprocating part that moves forward and backward in the device's longitudinal direction. A locking part can be engaged with or disengaged from the reciprocating part and that locks the movement of the reciprocating part by engaging with the reciprocating part. A first elastic part applies force to the locking part so as to move the locking part so as to disengage the locking part from the reciprocating part. A second elastic part applies force to the locking part so as to move the locking part so as to engage the locking part with the reciprocating part. A holding means holds the first elastic part so that the first elastic part stores an elastic force larger than the maximum elastic force of the second elastic part, and that that prevents the elastic force of the first elastic part from acting against the second elastic part when the second elastic part moves the locking part so as to engage the locking part with the reciprocating part.

In a further aspect of the invention, the device includes a delay mechanism for delaying the action of engaging and disengaging the locking part with and from the reciprocating part.

In yet a further aspect of the invention, the locking part, the first elastic part, and the second elastic part of the slide locking device are serially arranged along the moving direction of the reciprocating part.

In yet another aspect of the invention a slide locking device includes holding means which have a setting member that sets the first elastic part in a condition for storing an elastic force larger than the maximum elastic force of the second elastic part. The setting member can move in the direction for changing the elastic force of the first elastic part.

### ADVANTAGES OF THE INVENTION

According to the present invention, the holding means holds the first elastic part in a condition so that the first elastic part stores an elastic force larger than the maximum elastic force of the second elastic part, so that locking of the locking part can be released smoothly. The holding means prevents the elastic force of the first elastic part from acting against the second elastic part when the second elastic part moves the locking part in the direction so as to engage with the reciprocating part, so that locking of the locking part is done smoothly. In the present invention, the movement of the reciprocating part in the linear direction and the locking of that movement are done smoothly. Therefore, the present invention is incorporated in a device such as a door-opening-assistance device, so that the device can be smoothly actuated or locked.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTIONS OF THE DRAWINGS

Other characteristics and advantages of the invention will become apparent with the aid of the description which follows in conjunction with the appended drawings which represent:

FIG. 1 is a front view of a door closer that includes the present invention's slide locking device.

FIG. 2 is a left-side view of the door closer shown in FIG. 1.

FIG. 3 is a cross-section view along the line A-A of FIG. 2.

FIG. 4 is a cross-section view along the line B-B of FIG. 3.

FIG. 5 is a cross-section view along the line C-C of FIG. 3.

FIG. 6 is a cross-section view along the line D-D of FIG. 3.

FIG. 7 is a cross-section view along the line E-E of FIG. 3.

FIG. 8 is a cross-section view showing the interior of the slide locking device.

FIG. 9 is a cross-section view corresponding to FIG. 3, showing the condition after the door-opening assistance operation has been completed.

FIG. 10 is a cross-section view corresponding to FIG. 4, showing the condition after the door-opening assistance operation has been completed.

FIG. 11 is a cross-section view corresponding to FIG. 5, showing the condition after the door-opening assistance operation has been completed.

FIG. 12 is a cross-section view corresponding to FIG. 3, showing the condition for storing the opening force.

FIG. 13 is a cross-section view corresponding to FIG. 4, showing the condition for storing the opening force.

FIG. 14 is a cross-section view corresponding to FIG. 5, showing the condition for storing the opening force.

FIG. 15 is a cross-section view corresponding to FIG. 3, showing the condition when storing of the opening force is stopped and the stored opening force is maintained.

FIG. 16 is a cross-section view corresponding to FIG. 4, showing the condition when storing of the opening force is stopped and the stored opening force is maintained.

FIG. 17 is a cross-section view corresponding to FIG. 5, showing the condition when storing of the opening force is stopped and the stored opening force is maintained.

FIG. 18 is a cross-section view corresponding to FIG. 3, showing the condition immediately before the door is completely closed.

FIG. 19 is a cross-section view corresponding to FIG. 4, showing the condition immediately before the door is completely closed.

FIG. 20 is a cross-section view corresponding to FIG. 5, showing the condition immediately before the door is completely closed.

FIG. 21 is a cross-section view corresponding to FIG. 3, showing the condition when the door is completely closed.

FIG. 22 is a cross-section view corresponding to FIG. 4, showing the condition when the door is completely closed.

FIG. 23 is a cross-section view corresponding to FIG. 5, showing the condition when the door is completely closed.

FIG. 24 is a cross-section view that shows the actions of an unlocking spring and a locking spring in the conditions shown by FIGS. 3 to 5.

FIG. 25 is a cross-section view that shows the actions of an unlocking spring and a locking spring in the condition shown by FIGS. 9 to 11.

FIG. 26 is a cross-section view that shows the actions of an unlocking spring and a locking spring the condition shown by FIGS. 12 to 14.

FIG. 27 is a cross-section view that shows the actions of an unlocking spring and a locking spring in the condition shown by FIGS. 15 to 17.

FIG. 28 is a cross-section view that shows the actions of an unlocking spring and a locking spring in the condition shown by FIGS. 18 to 20.

FIG. 29 is a cross-section view that shows the actions of an unlocking spring and a locking spring in the condition shown by FIGS. 21 to 23.

FIG. 30 is a cross-section view of another embodiment of the slide locking device.

FIG. 31 is a cross-section view of another door-opening-assistance device that includes the present invention's slide locking device.

FIG. 32 is a cross-section view perpendicular to the view of the door-opening-assistance device shown in FIG. 31.

### EXPLANATION OF NUMBERS IN THE DRAWINGS

1 door closer
1a closer device
1b door-opening-assistance device
5 pinion
5a cam surface
6 case
9 cylinder
14 closing spring
20 block
21 piston (reciprocating part)
22 opening spring
23 unlocking pin
24 unlocking spring
25 stop pin
26a, 26b spring bearings
27 locking ball
28 locking pin
29 locking spring
101 locking part
102 holding means
103 setting members
104 sliding members
105 unlocking mechanism
106 locking mechanism

### BEST MODE FOR CARRYING OUT THE INVENTION

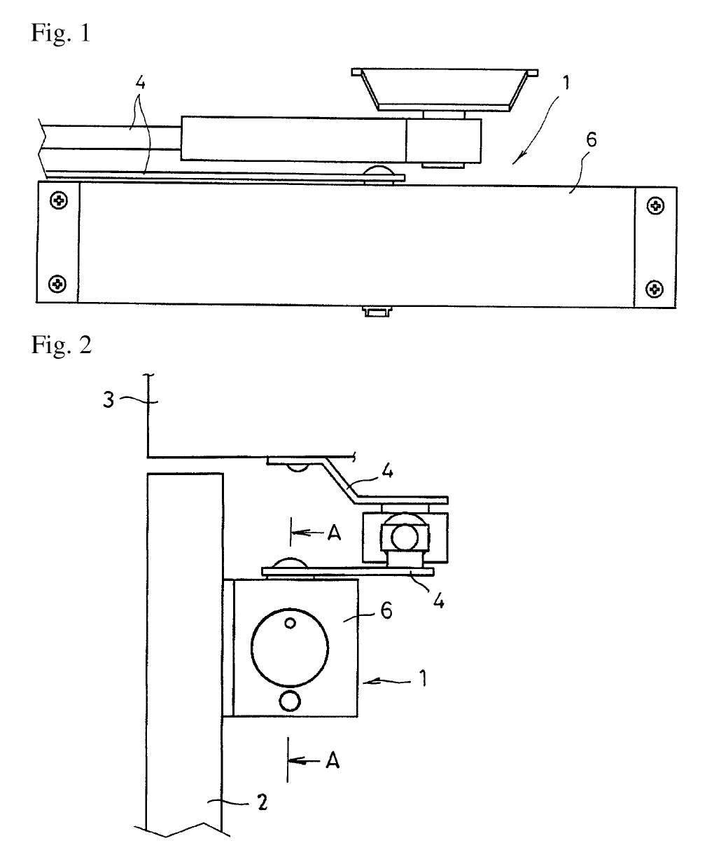

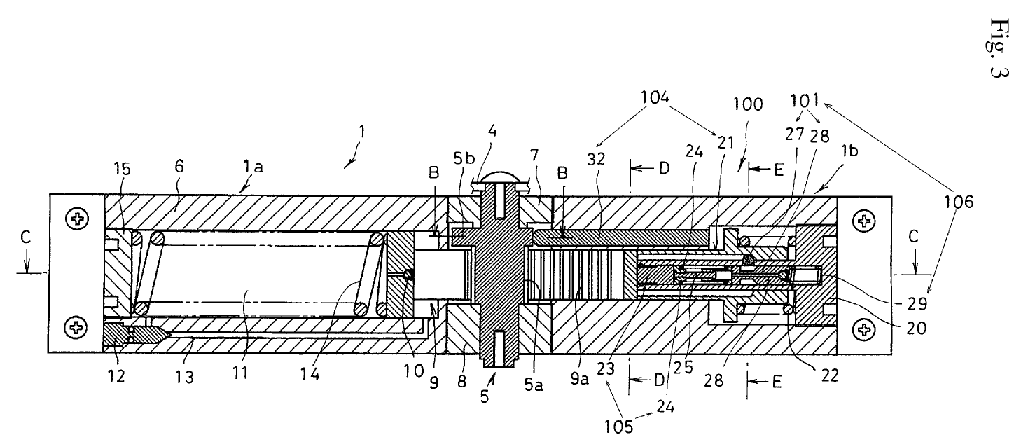

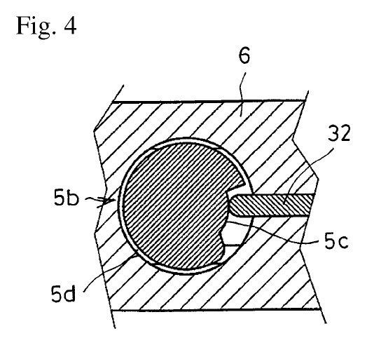

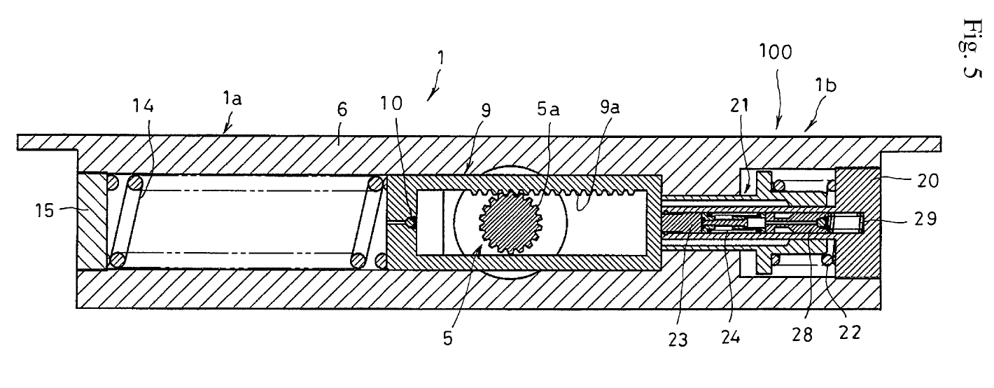

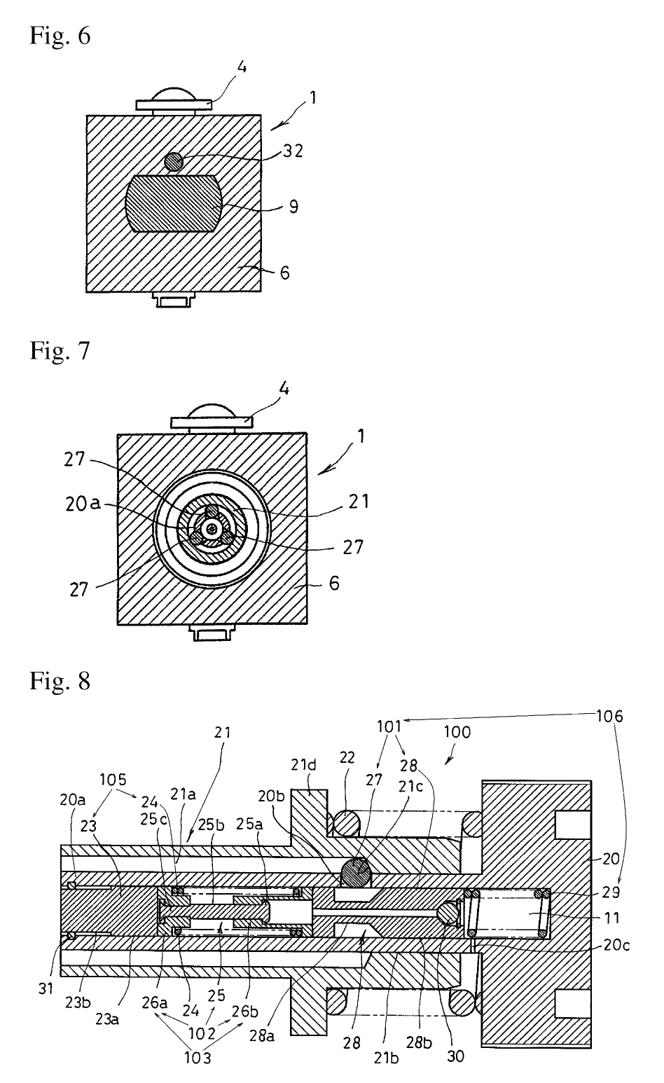

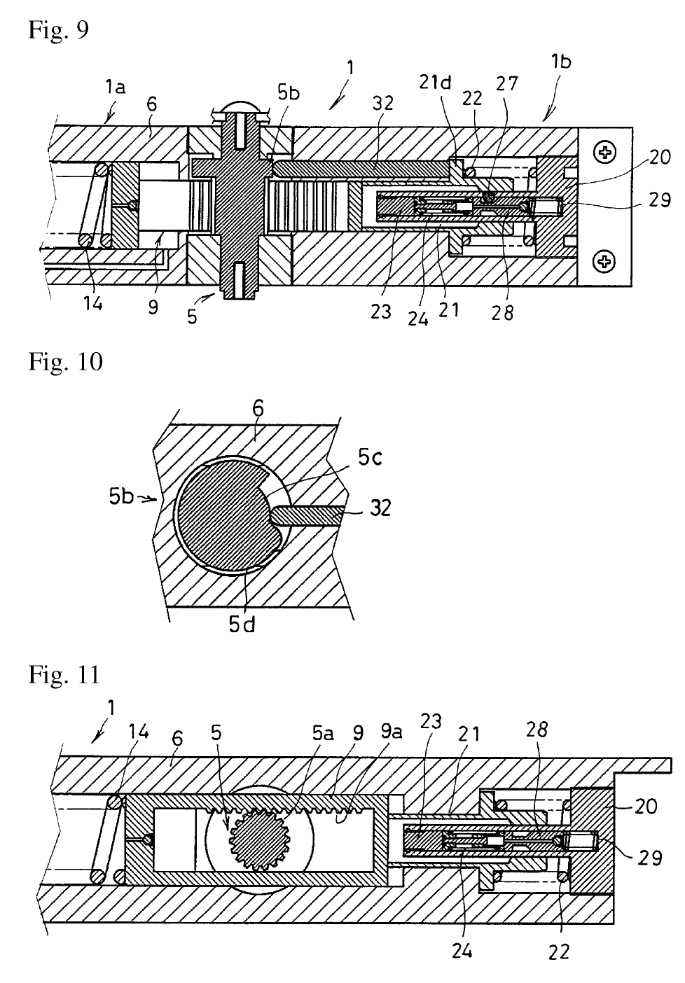

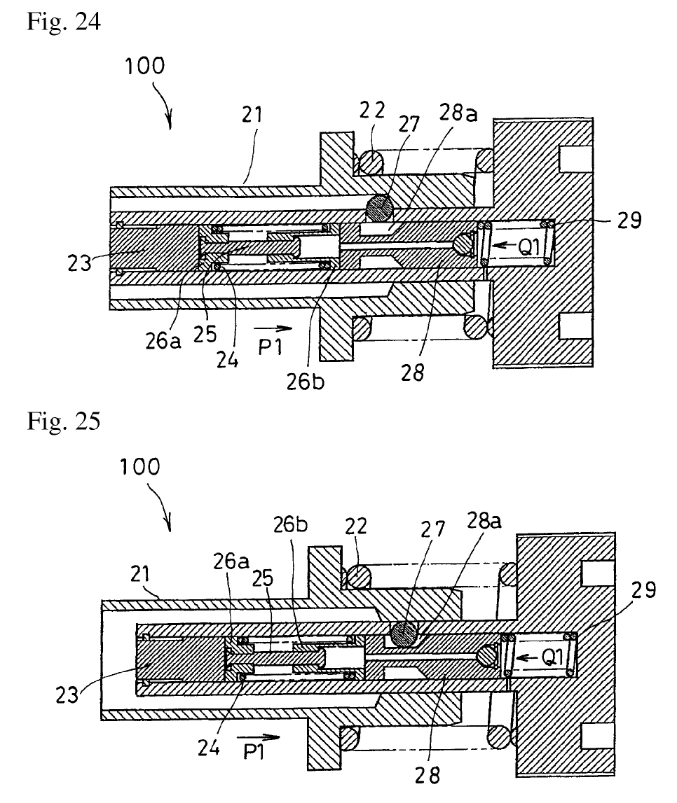

The slide locking device of the present invention will now be described in detail with reference to an embodiment in which the slide locking device is incorporated in a door-opening-assistance device. In this embodiment, the door-opening-assistance device is structured so as to be integrated with a door closer. Accordingly, the slide locking device is also incorporated in the door closer. FIGS. 1 to 29 show one embodiment of the door closer. FIG. 1 is a front view, FIG. 2 is a left side view of the door closer shown in FIG. 1, FIG. 3 is a cross-section view along the line A-A of FIG. 2, FIG. 4 is a cross-section view along a line B-B of FIG. 3, FIG. 5 is a cross-section view along a line C-C of FIG. 3, FIG. 6 is a cross-section view along a line D-D of FIG. 3, FIG. 7 is a cross-section view along a line E-E of FIG. 3, FIG. 8 is a cross-section view of the interior of the slide locking device, FIGS. 9 to 23 show the actions of the door closer, and FIGS. 24 to 29 show the actions of the slide locking device corresponding to FIG. 8.

As shown in FIG. 8, a slide locking device 100, which is incorporated in a door closer 1, consists of a piston 21 as a reciprocating part that moves forward and backward in the longitudinal direction, a locking part 101, that can be engaged with or disengaged from said piston 21, and that locks the movement of the piston 21 by engaging with the piston 21, an unlocking spring 24 as a first elastic part that applies force to the locking part 101 so as to move the locking part 101 in the direction for disengaging the locking part 101 from the piston 21, a locking spring 29 as a second elastic part that applies force to the locking part 101 so as to move the locking part 101 in the direction for engaging the locking part 101 with the piston 21, and a holding means 102 that holds the unlocking spring 24 so that the unlocking spring 24 stores an elastic force (spring force) larger than the maximum elastic force (maximum spring force) of the locking spring 29, and that prevents the elastic force (spring force) of the unlocking spring 24 from acting on the locking spring 29 when the locking spring 29 moves the locking part 101 so as to engage the locking part 101 with the piston 21.

Here, the locking part 101 consists of locking balls 27 that are detachably engaged with the piston 21, and a locking pin 28 that is positioned between the unlocking spring 24 and the locking spring 29, that pushes and thereby moves the locking balls 27 so as to engage with the piston 21, and that receives the locking balls 27 after they have been disengaged from the piston 21.

Also, the holding means 102 consists of a stop pin 25, and a pair of spring bearings 26a, 26b (a first spring bearing 26a, and a second spring bearing 26b) that are mounted in the longitudinal direction to the two ends of the stop pin 25.

A pair of the spring bearings 26a, 26b constitute setting members 103 that set the unlocking spring 24 at an initial load (this initial load stores a spring force larger than the maximum spring force of the locking spring 29), with the second spring bearing 26b able to move in the direction for changing the spring force of the unlocking spring 24.

In the slide locking device 100 consisting of the above-mentioned members, a check valve 30 is arranged as a delaying mechanism. The structures of the check valve 30, the locking pin 28, the stop pin 25, and the pair of spring bearings 26a, 26b will be described later. Also, in the slide locking device 100 of this embodiment, the unlocking spring 24, the locking pin 28 of the locking part 101, and the locking spring 29 are serially arranged along the moving direction of the piston 21, which is a reciprocating part. These members are serially arranged so that the expansion and compression of the unlocking spring 24 and the locking spring 29, and the linear movement of the locking pin 28, are done smoothly, so that locking and unlocking actions can be done smoothly.

As shown in FIGS. 1 and 2, the door closer 1 is mounted by screws and the like at the top on the inner side or outer side of a door 2, and is connected to a wall 3 via two parallel arms 4. The door closer 1 has a flat elongated case 6, and a closer device 1a and a door-opening-assistance device (hereinafter “opening-assistance device”) 1b are arranged in the case 6.

As shown in FIG. 3, the closer device 1a, which rotates and applies force to the door 2 in the door-closing direction, consists of (1) a pinion 5 that is connected with an arm 4, (2) a cylinder 9 that meshes with the pinion 5 and moves forward and backward along the longitudinal direction of the case 6, and (3) a closing spring 14 that is made of a coil spring that applies force to the door 2 in the door-closing direction. The closer device 1a is arranged in the left half of the case 6, with the pinion 5 as a border between the closer device 1a and the door-opening-assistance device 1b.

One end (the left end in FIG. 3) of the case 6 is sealed by screwing a cover 15 thereon, and the other end (the right end in FIG. 3) is sealed by screwing a block 20—which is a stationary member, and which will be described later—thereon. The case 6 in a sealed condition is filled with oil 11.

The pinion 5 is arranged at the approximate longitudinal center of the case 6, and it is rotatably supported by plate-like supporting members 7 and 8, which are screwed and fixed on the top and bottom surfaces, respectively, of the case 6 at the approximate longitudinal center of the case 6. The rotary force of the door 2 is transmitted to the pinion 5 via the arm 4, and the pinion 5 rotates in forward and reverse directions together with the opening and closing, respectively, of the door 2. In this embodiment, the pinion 5 rotates in the counterclockwise direction when the door 2 is opened, and rotates in the clockwise direction when the door 2 is closed. A pinion gear 5a that meshes with the cylinder 9 is formed at the longitudinal center of the pinion 5, and a flange-like cam face 5b is formed in the upper part of the pinion gear 5a.

The cam face 5b of the pinion 5 contacts the tip of a shaft part 32, described below, and is configured so that the small-diameter part 5c of the pinion 5 connected with the large-diameter part 5d in the circumferential direction, as shown in FIG. 4. One of the boundary portions between the small-diameter part 5c and the large-diameter part 5d is formed into a smooth inclined surface, so that the shaft part 32 can move between the small-diameter part 5c and the large-diameter part 5d.

As shown in FIG. 5, the cylinder 9 is formed into an elongated and approximately rectangular shape when seen from a plane view, and a rack 9a that meshes with the pinion gear 5a of the pinion 5 is formed on one inner surface in the longitudinal direction of the cylinder 9. When the pinion 5 rotates in the door-opening direction, i.e., the counterclockwise direction, the cylinder 9 moves in the case 6 to the left of FIG. 5, and when the pinion 5 moves in the door-closing direction, i.e., the clockwise direction, the cylinder 9 moves to the right.

As shown in FIG. 3, the closing spring 14 is arranged between the cylinder 9 and the cover 15, and it applies force to the cylinder 9 to move the cylinder 9 in the door-closing direction, i.e., to the right in FIG. 3. By this movement of the cylinder 9 in the door-closing direction, the pinion 5 also moves in the door-closing direction, i.e., the clockwise direction. Accordingly, the closing spring 14 applies force to the door 2 in the closing direction via the cylinder 9 and the pinion 5, so that the door 2 automatically closes itself.

A check valve 10 is installed on the side surface of the closing spring 14 in the cylinder 9. When the cylinder 9 moves in the door-closing direction, i.e., to the right in FIG. 3, the closing speed is slowed by the resistance of oil 11, so that the door 2 can be closed slowly. As shown in FIG. 3, the flow path 13 of the oil 11 is formed in the case 6 so as to correspond to the check valve 10, and the flow path 13 is passed through into the inside of the case 6. A regulating valve 12 is installed at the front end of the flow path 13, and the volume of the oil flowing in the flow path 13 can be regulated by operating the regulating valve 12 to move forward and backward. Thereby, the extent of the above-described slowing can be adjusted.

As shown in FIGS. 3 and 8, the opening-assistance device 1b includes a block 20 as a stationary member, sliding members 104 that consists of a piston 21 and a shaft part 32, an unlocking mechanism 105 that consists of an unlocking pin 23 and the above-described unlocking spring 24, a locking mechanism 106 that consists of the above-described locking balls 27, the locking pin 28, and the locking spring 29, and an opening spring 22.

These components are arranged inside the right half of the case 6, with the pinion 5 as a border between the closer device 1a and the opening-assistance device 1b. In this manner, the closer device 1a is arranged in the left half of the case 6, and the opening-assistance device 1b is arranged in the right half, so that the closer device 1a and the opening-assistance device 1b are arranged inside the case 6 in a row along the longitudinal direction of the cylinder 9. Therefore, the door closer 1 can be made entirely flat and compact, so that its appearance and handling properties are improved.

The block 20 is screwed to and fixed to the right end of the case 6. A guide cylinder 20a, extending along the moving direction of the cylinder 9 toward the cylinder 9, is integrally formed on the block 20. A shaft part 32 and the above-described piston 21 are arranged on the outer periphery of the guide cylinder 20a, and an unlocking mechanism 105 consisting of an unlocking pin 23 and an unlocking spring 24, and a locking mechanism 106 consisting of a locking pin 28 and a locking spring 29, are arranged on the inner periphery of the guide cylinder 20a.

As described above, the shaft part 32 contacts the cam face 5b of the pinion 5, and moves to the right and left in the case 6 on the outer periphery of the guide cylinder 20a along the guide cylinder 20a. Also, the piston 21 moves to the right and left in the case 6 along the guide cylinder 20a. The piston 21 is moved by the force of the opening spring 22 and the force of the shaft part 32.

As shown in FIG. 8, the piston 21 has a collar 21d that extends around the piston 21, and the opening spring 22 is arranged between the collar 21d and the block 20. Also, the collar 21d can contact the shaft part 32, and from such contact the collar 21d receives a moving force from the shaft part 32. A large-diameter hole 21a and a small-diameter hole 21b are formed inside the piston 21, and the guide cylinder 20a of the block 20 slides on the small-diameter hole 21b. A tapered face 21c is formed at the boundary between the small-diameter hole 21b and the large-diameter hole 21a, and each of the locking balls 27 is arranged at the tapered face 21c.

Each of the locking balls 27 is provided at a position that corresponds to a through-hole 20b on the guide cylinder 20a, and each ball can freely go into or out of the through-hole 20b. Each of the locking balls 27 contacts the tapered face 21c of the piston 21 while the ball is in its respective through-hole 20b, so that the ball locks the movement of the piston 21. As shown in FIG. 7, three locking balls 27 are arranged at three equally-divided positions along the circumference of the guide cylinder 20a. Therefore, each of the locking balls 27 has an equal locking action on the inner circumference of the piston 21.

The locking pin 28 of the locking mechanism 106 consists of the small-diameter part 28a and the large-diameter part 28b, and each of the locking balls 27 can fall into the small-diameter part 28a, as a result of which the locking balls 27 release the locking of the piston 21. Meanwhile, the large-diameter part 28b acts to maintain the condition of the locking ball 27 in contact with the tapered face 21c of the piston 21, so that the piston 21 is brought into a locked condition. The locking spring 29 is a coil spring that forces the locking pin 28 to move the locking pin 28 toward the cylinder 9.

The unlocking pin 23 of the unlocking mechanism is arranged at the tip of the guide cylinder 20a, i.e., on the cylinder 9 side, and said pin moves forward and backward inside the guide cylinder 20a. The forward movement of the unlocking pin 23 is stopped by bringing the unlocking pin 23 into contact with the restraining ring 31, which is a C-ring or the like that is fitted at the tip of the guide cylinder 20a.

The unlocking spring 24 is a coil spring that is arranged between the unlocking pin 23 and the locking pin 28. The unlocking spring 24 exerts a spring force against the locking spring 29. The stop pin 25, the first spring bearing 26a, and the second spring bearing 26b are installed onto the unlocking spring 24 in an assembled condition.

As shown in FIG. 8, the stop pin 25 is structured such that a large-diameter part 25a, a middle-diameter part 25b, and a small-diameter part 25c are integratedly formed in the longitudinal direction. The first spring bearing 26a is arranged on the unlocking pin 23 side and is fixed to the stop pin 25 by clamping the end of the small-diameter part 25c of the stop pin 25. The second spring bearing 26b is arranged on the locking pin 28 side and slides along the middle-diameter part 25b of the stop pin 25. The second spring bearing 26b stops sliding when it contacts the large-diameter part 25a of the stop pin 25. The unlocking spring 24 is arranged between the first spring bearing 26a and the second spring bearing 26b under the condition that the unlocking spring 24 is compressed so as to set the initial load of the spring force of the unlocking spring 24. When the opening spring 22 exerts the opening force, the thus-set unlocking spring 24 has a spring force larger than the force of the locking spring 29, and when the opening spring 22 is locked under the condition that the opening force is stored, the thus-set unlocking spring 24 does not influence the action of the locking spring 29.

As shown in FIG. 8, the check valve 30 is installed at the end of the locking pin 28, and the small-diameter flow path 20c is formed at the base of the guide cylinder 20a that corresponds to the check valve 30. Thereby, the oil 11 can circulate in the guide cylinder 20a and the case 6.

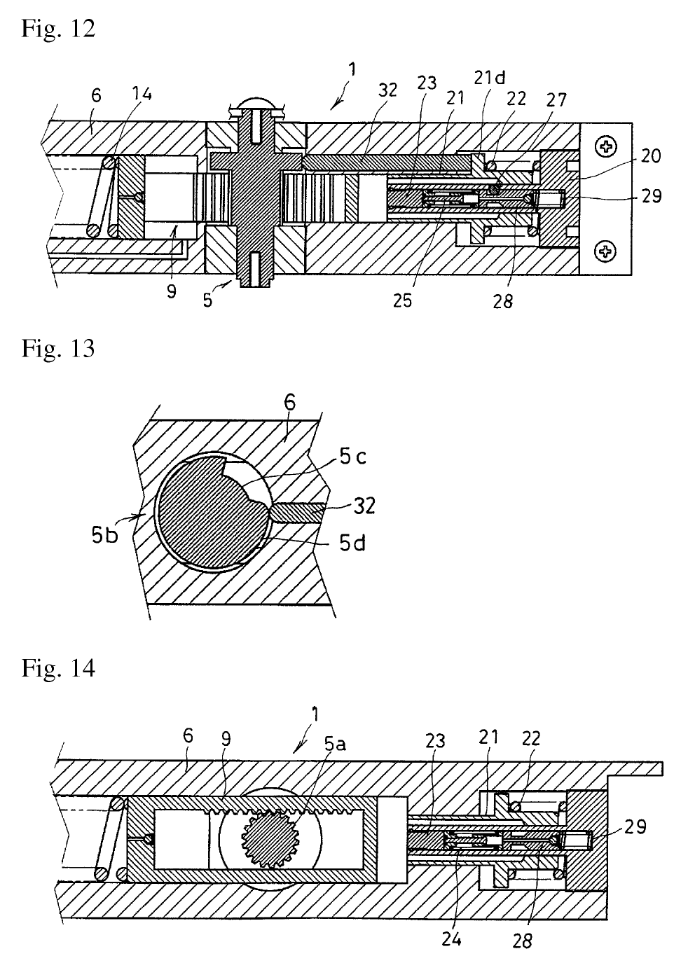

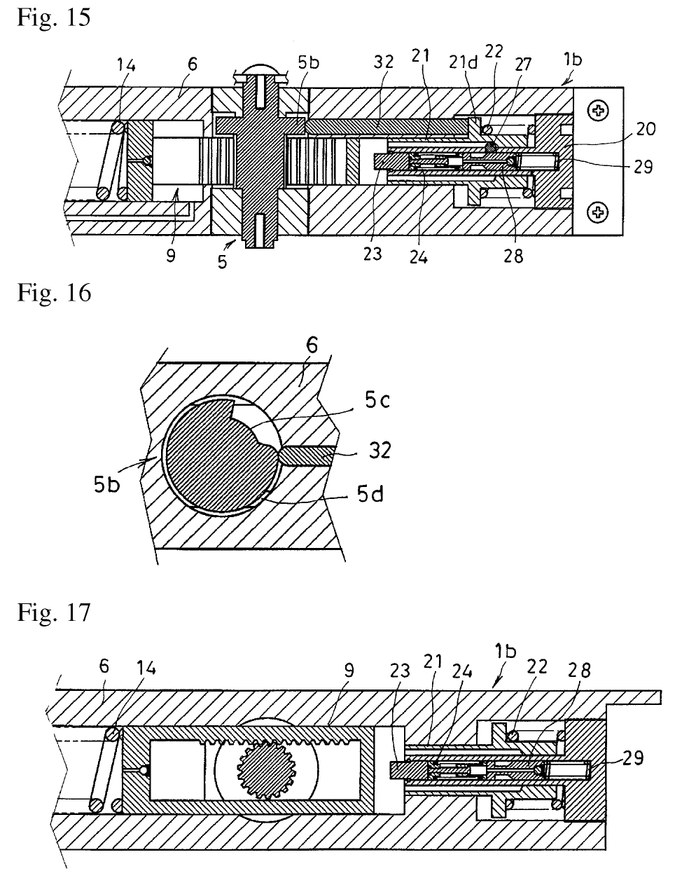

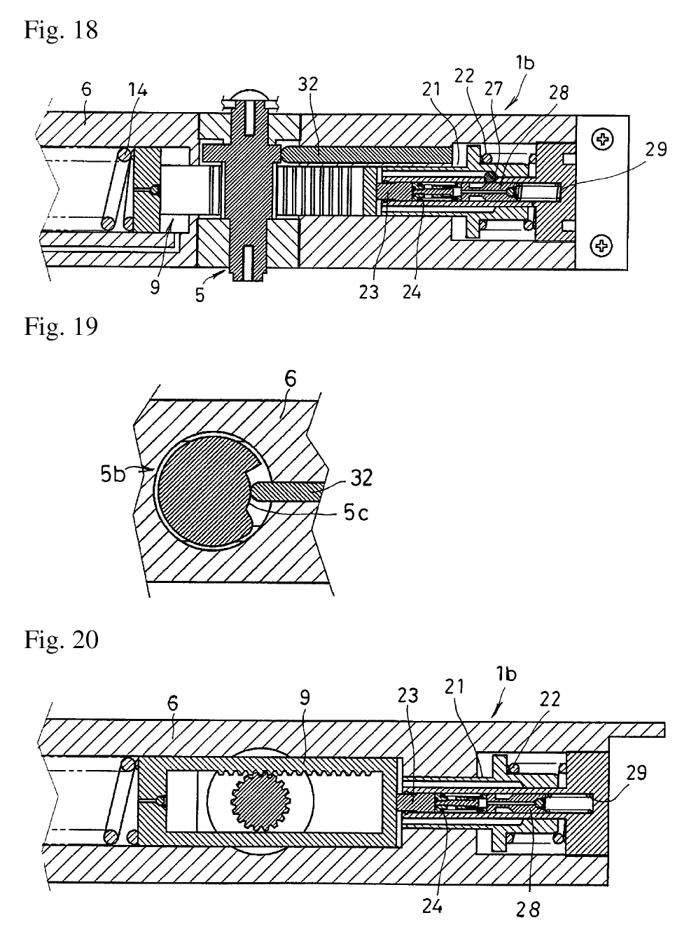

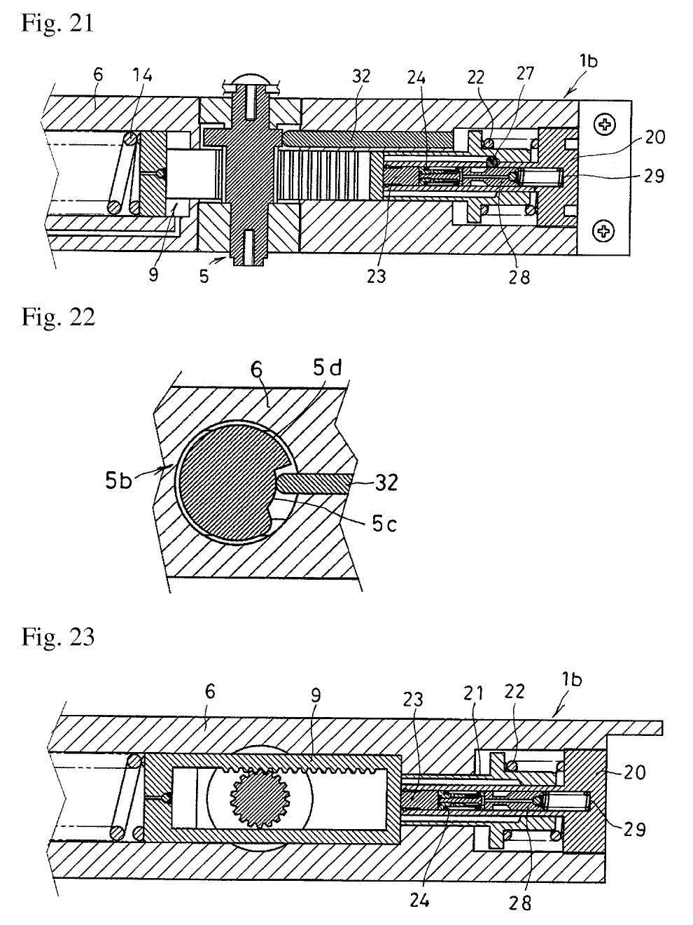

The actuation of the above-mentioned door closer 1 will now be explained. FIGS. 3 to 5 show the door closer 1 when a door 2 is in a fully closed condition and locked by a latch lock (not shown). Under this fully closed condition of the door 2, the opening-assistance device 1b is unlocked. FIGS. 9 to 11 show the initial condition when the opening-assistance device 1b is unlocked and the door begins to open from its fully-closed condition. In this condition, the opening-assistance device 1b is exerting its door-opening force. FIGS. 12 to 14 show the condition when the door 2 continues to open following the condition shown in FIGS. 9 to 11. In this condition, the opening spring 22 accumulates the force for opening the door 2. FIGS. 15 to 17 show a condition where the opening spring 22 has finished accumulating the opening force, and the opening spring 22 is locked under a state in which the accumulated opening force is stored therein. FIGS. 18 to 20 show the condition when the door 2 is almost fully closed, and FIGS. 21 to 23 show the condition when the door 2 is fully closed.

As shown in FIGS. 3 and 5, when the opening-assistance device 1b is in the unlocked condition, the unlocking pin 23 is pressed—by the cylinder 9—in the door-opening direction 2 (i.e., to the right in FIGS. 3 and 5). In this situation, the initial load of the spring force that is set in the unlocking spring 24 is larger than the spring force of the locking spring 29, as described below. Therefore, the locking pin 28 is pressed in the same direction (i.e., to the right) and the small-diameter part 28a reaches the position where the locking balls 27 are arranged. In this situation, the opening spring 22 is compressed to the maximum level and, due to the spring force of the opening spring 22, the tip of the piston 21 presses the cylinder 9 in the door-opening direction 2 (i.e., to the left in FIGS. 3 and 5). The shaft part 32 is in a free condition between the small-diameter part 5c of the cam 5b of the pinion 5 and the collar 21d of the piston 21.

In the condition shown in FIGS. 3 to 5, when the latch lock is unlocked and the door 2 is actuated to be opened, the condition of the door closer 1 changes to that shown in FIGS. 9 to 11. FIGS. 9 to 11 show the condition when the door 2, after rotating from the fully-closed condition into the area where the opening of the door is assisted, has passed beyond that opening-assistance area. When the latch lock is released and the door 2 is actuated to be opened, the piston 21, which is energized by the opening spring 22, presses the cylinder 9 in the door-opening direction (to the left in FIGS. 3 and 5). This direction is opposite to a direction in which the closing spring 14 of the closer device 1a applies force to the cylinder 9, and the cylinder 9 moves in the door-opening direction against the spring force of the closing spring 14. Therefore, the door 2 can be opened by a small amount of force applied by a person.

Meanwhile, the tapered face 21c of the piston 21 presses the locking balls 27 in the door-opening direction, so that a component of a force acts on an each of the locking balls 27 in the direction for dropping the locking balls 27 in the small-diameter part 28a of the locking pin 28. Accordingly, when the locking balls 27 pressed by the piston 21 fall against the small-diameter part 28a, the piston 21 can move in the door-opening direction (to the left in FIGS. 3 and 5).

Because the locking balls 27 fall against the small-diameter part 28a of the locking pin 28, the locking pin 28 is prevented from moving. Thus, the locking spring 29 is held in a compressed condition, and therefore, the stop pin 25 and the spring bearings 26a, 26b apply the initial load on the unlocking spring 24. Under this condition, and due to the spring force of the opening spring 22, the door 2 can be opened by a small amount of force applied by a person. The shaft part 32, which has moved to the position where the door-opening assistance ceases, contacts an end of the small-diameter part 5c of the cam face 5b of the pinion 5, and comes between the small-diameter part 5c and the collar 21d of the piston 21.

When the door 2 is further opened after passing beyond the position, shown in FIGS. 9 to 11, where the door-opening assistance ceases, the pinion 5 rotates and therefore the shaft part 32—which was in contact with the small-diameter part 5c—slides on the smooth inclined surface of the cam face 5b from the small-diameter part 5c and then contacts the large-diameter part 5d of the cam face 5b, as referred to FIGS. 12 to 14. Therefore, the shaft part 32 moves to the right (in the figures), and the piston 21 is pressed in the same direction by the shaft part 32. Thus, the opening spring 22 is compressed, so as to accumulate the door-opening force for opening the door 2. Other parts maintain the condition shown in FIGS. 9 to 11.

By the movement to be referred to FIGS. 12 to 14, the locking ball 27 reaches a position that corresponds to the large-diameter hole 21a of the piston 21. FIGS. 15 to 17 show the subsequent condition, after the locking balls 27 have reached a position that corresponds to the large-diameter hole 21a of the piston 21. In this situation, the unlocking spring 24 maintains the initial load, which was set by the stop pin 25 and the spring bearings 26a, 26b; therefore, a spring force that acts on the outside of the unlocking spring 24, i.e., on the locking pin 28, is not generated in the unlocking spring 24. The locking spring 29 is held in the compressed condition shown in FIGS. 9 to 11, and therefore, due to the spring force of the locking spring 29, the locking pin 28 moves to what in FIGS. 9 and 11 is leftward. Also, under this condition, the locking balls 27 are outside the small-diameter hole 21b of the piston 21, and therefore, the locking ball 27 is pressed by the large-diameter part 28b of the locking pin 28 to the outside of the through-hole 20b, and the locking balls 27 then contact the tapered face 21c of the piston 21. The piston 21 is thus locked.

This locked condition that results from the above-mentioned movement of the locking balls 27 continue thereafter, so that the opening-assistance device 1b does not contribute to the opening or closing of the door 2 even when the door 2 is opened further. As described above, in such a structure that, after the opening spring 22 has exerted its force for opening the door 2 at the initial stage of the opening of the door 2, the opening spring 22 accumulates opening force for opening the door 2, and then is locked under the condition that the opening spring 22 stores the accumulated force for opening the door 2, both the door-opening-assistance action and the storing of the door-opening force can be consecutively completed before the door 2 is opened wide enough for a person to walk through the doorway. Therefore, even if the door 2 is opened and then closed before the door 2 is completely opened, there does not occur a malfunction such that the opening spring 22 fails to accumulate opening force.

FIGS. 18 to 20 show the condition immediately before the door 2 is almost completely closed. Due to the movement of the door 2 when it is being closed, the pinion 5 rotates in the clockwise direction, and along with this rotation, the tip of the cylinder 9 abuts the unlocking pin 23, so that the unlocking pin 23 moves in the direction that is to the right in FIGS. 18 to 20. The unlocking spring 24 is gradually compressed by this movement. At that time, the locking of the piston 21 by the locking balls 27 is still maintained.

When the door 2 is completely closed subsequent to the conditions shown in FIGS. 18 to 20, the condition changes to that shown in FIGS. 21 to 23. As described below, at the fully-closed position of the door 2, the spring force of the unlocking spring 24 is set larger than the combined force of the force of the locking balls 27 pressing the locking pin 28 and the spring force of the locking spring 29; therefore, the locking pin 28 moves in the direction that is to the right in FIGS. 21 to 23 and compresses the locking spring 29. During this movement, the movement of the locking pin 28 is slowed by the action of the check valve 30. Thus, the locking pin 28 moves slowly until the small-diameter part 28a has moved to a position that corresponds to that of an each of the locking balls 27. Due to this slowing of the movement of the locking pin 28, the condition changes into the unlocked condition shown in FIGS. 3 to 5 after the latch lock of the door 2 is locked.

In the above-mentioned structure, both the opening-assistance device 1b, which applies force to facilitate the movement of the door in the door-opening direction, and the closer device 1a, which acts to rotate the door in the door-closing direction, are arranged inside the same case 6, so that the device can be made compact and so that its appearance is improved. Also, the opening-assistance device 1b and the closer device 1a are interlinked with the opening of the door 2, so that troublesome adjustment is not required. In addition, the number of parts is reduced, which leads to less malfunctioning of the door closer 1.

The actions of the slide locking device 100 in the above-mentioned situations will now be explained with reference to FIGS. 24 to 29. Here, FIG. 24 corresponds to FIGS. 3 to 5, FIG. 25 corresponds to FIGS. 9 to 11, FIG. 26 corresponds to FIGS. 12 to 14, FIG. 27 corresponds to FIGS. 15 to 17, FIG. 28 corresponds to FIGS. 18 to 20, and FIG. 29 corresponds to FIGS. 21 to 23.

As described above, the unlocking spring 24 is set to both the first spring bearing 26a and the second spring bearing 26b. The second spring bearing 26b can slide in the longitudinal direction of the stop pin 25, and this sliding is stopped at the large-diameter part 25a of the stop pin 25. In the condition shown in FIGS. 3 to 5, where the latch lock of the door 2 is locked and the opening-assistance device 1b is unlocked, the unlocking spring 24 has an initial load P1 set at an initial stage, as shown in FIG. 24, and a force R to act on the outside of the unlocking spring 24 is not generated in the unlocking spring 24 (R=0). Meanwhile, the locking spring 29 is compressed to the maximum extent, and its load is Q1. The load when the locking spring 29 is extended to the maximum extent is Q2.

When the locking spring 29 is extended to the maximum extent, the relationship of the forces between that of the unlocking spring 24 and that of the locking spring 29 satisfies the following formula: Q2, Q1<P1. Also, because of the cylinder 9, the unlocking pin 23 cannot move leftward, and thus the relationship Q1<P1 is satisfied. Further, the force to act on the outside of the unlocking spring 24 is zero (R=0), so that the locking spring 29 remains in the unlocked position.

When the door 2 is actuated to be opened from a fully-closed condition, moves in the opening-assistance area, and reaches the end point of the opening-assistance area (the condition shown in FIGS. 9 to 11), the locking balls 27 fall against the small-diameter part 28a, so that the locking pin 28 is locked, as shown in FIG. 25. At that time, the loads on the unlocking spring 24 and the locking spring 29 remain as shown in FIG. 24.

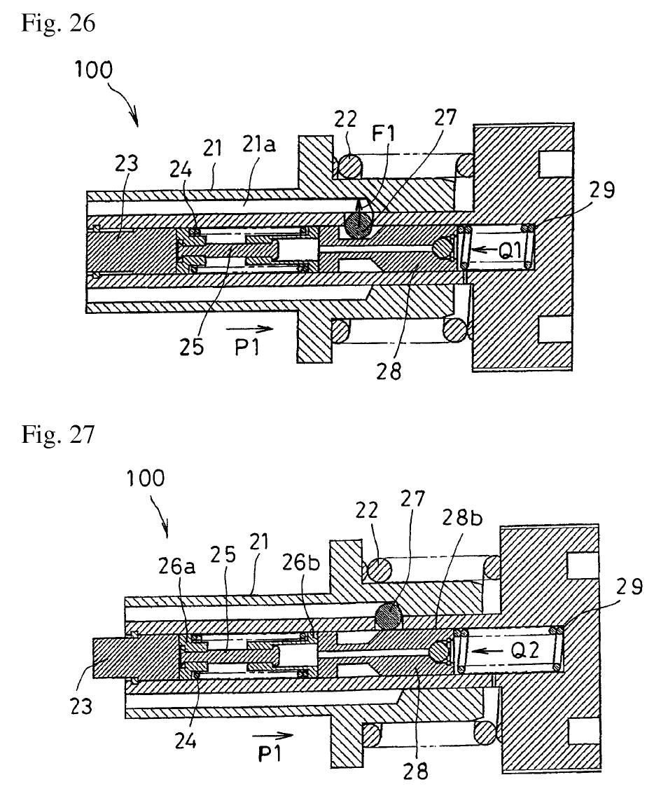

If the opening spring 22 is compressed so as to accumulate opening force (the condition shown in FIGS. 12 to 14), the locking balls 27 move in the direction of the piston 21 and the locking pin 28 is unlocked, as shown in FIG. 26. At that time, the force that moves an each of the locking balls 27 to the unlocking position is F1. There is no restriction on the unlocking pin 23, and therefore, the locking spring 29 presses the locking pin 28 with a force larger than the force F1, so that the locking pin 28 moves leftward.

If the opening spring 22 is locked while the opening force is being stored (the condition shown in FIGS. 15 to 17), the relationship of F1<Q2<Q1 is satisfied, and the force R acting on the outside of the unlocking spring 24 is zero. Therefore, as shown in FIG. 27, the locking pin 28 without fail moves to the locked position—i.e., due to the spring force of the locking spring 29, the locking pin 28 moves until the locking balls 27 contacts the tapered surface 21c of the piston 21.

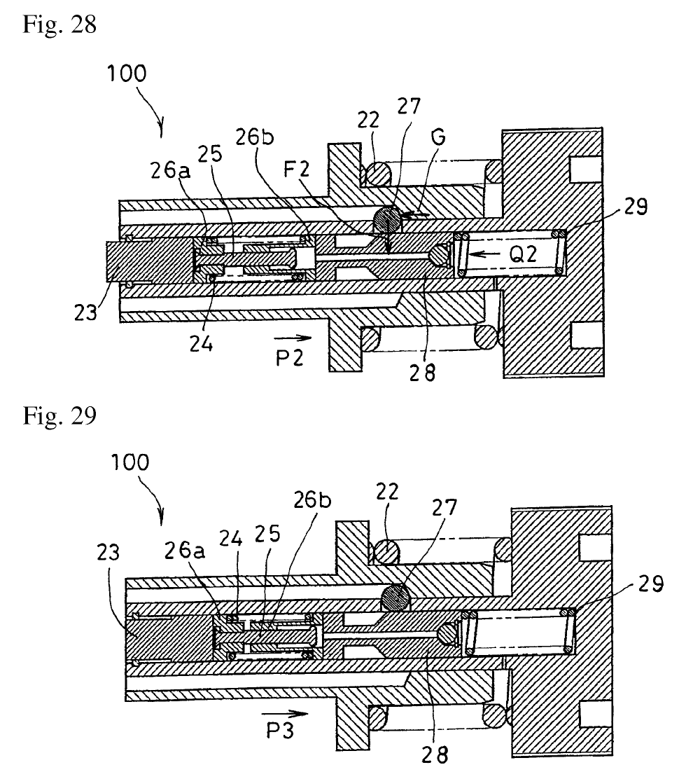

Under the condition that the door 2 is almost completely closed by the closing action (the condition shown in FIGS. 18 to 20), the unlocking spring 24 is compressed even more than when it was given its initial load, as shown in FIG. 28, and therefore the load applied on the unlocking spring 24 reaches P2. The force G acts against the locking balls 27 due to the spring force of the opening spring 22, so that the force F2 acts against the locking pin 28. The force that moves the locking pin 28 against this force F2 is expressed as F2×μ (μ is a friction coefficient). At that time, the relationship of P2≧(F2×μ)+Q2 is satisfied, so that the locking pin 28 starts moving rightward.

In this manner, in a structure such that the spring force of the opening spring 22 is made into a component of a force by the tapered surface 21c of the piston 21, and such that the locking pin 28 is locked by this component of the force, even if the spring force of the opening force 22 is large, the unlocking force can be small. Accordingly, the unlocking spring 24 can be made small. Furthermore, because an each of the locking balls 27 can rotate and escape to be subject to wear down, it has a long life.

Under the condition that the door 2 is completely closed (the condition shown by FIGS. 21 to 23), the unlocking spring 24 is compressed to its maximum extent, as shown in FIG. 29, and the load reaches P3. At that time, P3>(F2×μ)+Q2 is satisfied, so that the locking pin 28 can without fail move to the unlocked position, which is the condition shown by FIGS. 3 to 5. At the place where the movement of the locking pin 28 ends, the unlocking spring 24 has the initially applied load P1, and therefore the force R acting on the outside becomes zero. In addition, the relationship of P1>Q1 is satisfied, and therefore the locking pin 28 can stop at the unlocked position.

In the above-mentioned slide locking device 100, the initial load of the spring force on the unlocking spring 24 is set larger than the spring force of the locking spring 29, so that unlocking can be done smoothly. Also, the spring force of the unlocking spring 24 is suppressed by the initial load. Therefore, when the locking spring 29 presses the locking pin 28 so as to lock the piston 21 (see FIG. 26), the spring force of the unlocking spring 24 does not act against the locking spring 29, and thus, locking can be done without fail.

Also, in the slide locking device 100, the movement of the unlocking pin 23 is absorbed by the unlocking spring 24, and therefore, locking can be released when the spring force of the unlocking spring 24 becomes largest, so that a large damper effect is obtained. Furthermore, the locking pin 28 moves slowly due to the delaying action of the check valve 30, so that the timing of locking and unlocking can be set suitably.

In addition, in this slide locking device 100, an unlocking spring 24, spring bearings 26a, 26b, and a locking pin 28 are arranged inside a guide cylinder 20a of a block 20, and a piston 21 and an opening spring 22 are arranged outside the guide cylinder 20a, so that the device can be made compact. Also, even if the load of the opening spring 22 changes, the unlocking spring 24 can be changed accordingly, so that flexibility of designing the slide locking device 100 may be provided.

FIG. 30 shows another embodiment of the slide locking device 100. This embodiment provides an extension part 50 that elongates the end on the block 20 side of the locking pin 28 and projecting the extension part 50 outside the block 20. A rack 51 is formed as the outer end of the extension part 50, and a rotary damper 52 meshes with the rack 51. Accordingly, in this embodiment the locking pin 28 can be moved slowly by means of the rotary damper 52. In this structure, there is no need to arrange the check valve 30 inside the locking pin 28, and therefore the locking pin 28 can have a simple structure.

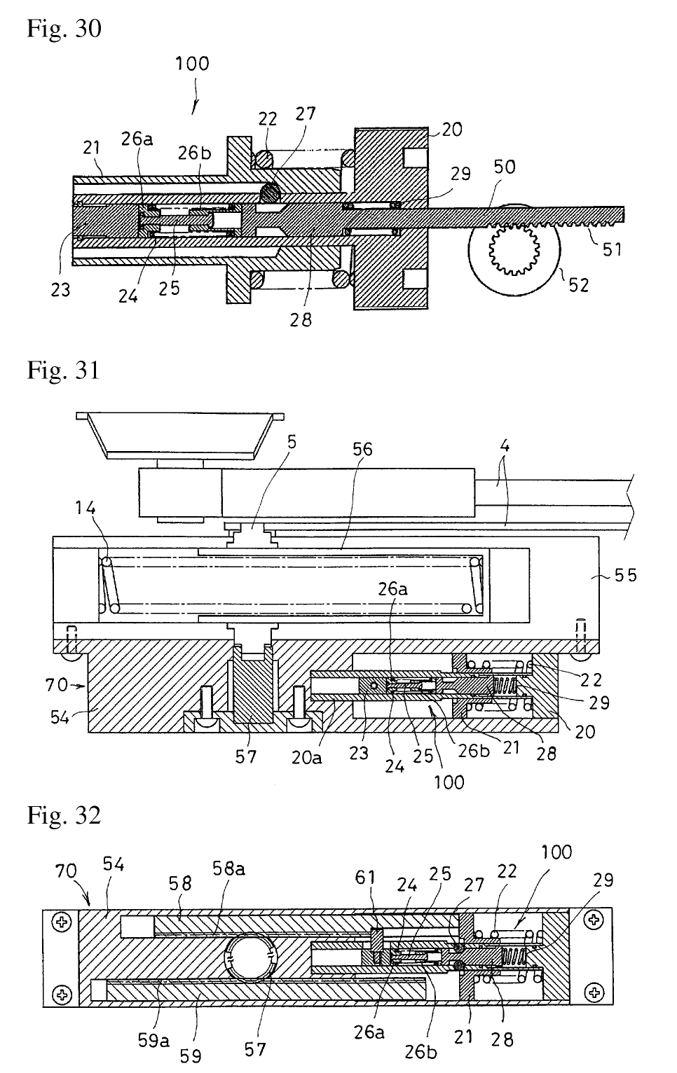

FIGS. 31 and 32 show an embodiment in which the slide locking device 100 of the present invention is applied to another opening-assistance device 70. Members identical to those in the above-mentioned embodiment shown in FIGS. 1 to 29 have identical reference numbers.

The opening-assistance device 70 in this embodiment is not integrally formed with the door closer, but is separately mounted onto the door closer. In the door closer, a closing spring 14 and a sliding member 56 are arranged in a closer case 55, and the sliding member 56 is connected with the pinion 5. The pinion 5 is connected with a door via two arms 4, and the pinion 5 rotates in forward and reverse directions together with the opening and closing, respectively, of the door. By this rotation, the sliding member 56 moves, and a door-closing spring force is accumulated in the closing spring 14.

The opening-assistance device 70 has a device case 54 that is to be mounted to the close case 55, and a drive shaft 57 and a pair of sliding racks 58, 59 are arranged inside the device case 54. The drive shaft 57 is fitted—in a noncircular manner—with the above-mentioned pinion 5, and rotates together with the rotation of the pinion 5. A pair of the sliding racks 58, 59 are arranged inside the device case 54 in the longitudinal direction of the device case 54, and their meshing parts 58a, 59a mesh with the drive shaft 57. Accordingly, the sliding racks 58, 59 slide in the longitudinal direction of the device case 54 due to the rotation of the drive shaft 57 and, vice versa, when the transmission members 58, 59 slide, the drive shaft 57 rotates.

In such a opening-assistance device 70, the slide locking device 100 is arranged at one longitudinal end of the sliding racks 58, 59. The slide locking device 100 has an opening spring 22, and a piston 21 that is a moving part, as is similar in the above-mentioned first embodiment. Also, the unlocking spring 24, the locking pin 28, and the locking spring 29 are serially arranged along the moving direction of the piston 21. The unlocking spring 24 is given an initial load by the stop pin 25 and the pair of spring bearings 26a, 26b. Also, the locking balls 27 are movably arranged between the locking pin 28 and the piston 21. In FIG. 32, number 61 denotes a unlocking bar that is arranged between the unlocking pin 23 and the transmission member 58.

The slide locking device 100 is incorporated in a opening-assistance device 70 such that the opening spring 22 accumulates the door-opening force at the initial stage of door opening, and applies said force to the transmission members 58, 59 under this door-opening-force-accumulating condition. Therefore, the slide locking device 100 can function in a manner similar to the embodiment shown in FIGS. 1 to 29.

The application of the above-mentioned embodiments of the slide locking device to the opening-assistance device has been discussed above. However, the present invention can be applied to any other device for locking and unlocking a part that can move forward and backward.

### INDUSTRIAL APPLICABILITY

The slide locking device of the present invention is suitable for a opening-assistance device, because it can smoothly lock or unlock the movement of a reciprocating part.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

1. A slide locking device having a longitudinal direction comprising:
a reciprocating part movable forward and backward in the longitudinal direction of the device,
a locking part engagable with or disengaged from the reciprocating part for locking the movement of the reciprocating part by engaging with the reciprocating part,
a first elastic part for applying force to the locking part so as to move the locking part so as to disengage the locking part from the reciprocating part,
a second elastic part for applying force to the locking part so as to move the locking part so as to engage the locking part with the reciprocating part, and
a holding means for holding the first elastic part so that the first elastic part stores an elastic force larger than the maximum elastic force of the second elastic part, and prevents the elastic force of the first elastic part from acting against the second elastic part when the second elastic part moves the locking part so as to engage the locking part with the reciprocating part.

2. The slide locking device according to claim 1, further comprising a delay mechanism for delaying the action of engaging and disengaging said locking part with and from the reciprocating part.

3. The slide locking device according to claim 1, wherein said locking part, said first elastic part, and said second elastic part are serially arranged along the moving direction of the reciprocating part.

4. The slide locking device according to claim 1, wherein:
said holding means has a setting member that sets the first elastic part in a condition for storing an elastic force larger than the maximum elastic force of the second elastic part, and
wherein the setting member can move in the direction for changing the elastic force of the first elastic part.

5. The slide locking device according to claim 2, wherein said locking part, said first elastic part, and said second elastic part are serially arranged along the moving direction of the reciprocating part.

6. The slide locking device according to claim 2 wherein:
said holding means has a setting member that sets the first elastic part in a condition for storing an elastic force larger than the maximum elastic force of the second elastic part, and
wherein the setting member can move in the direction for changing the elastic force of the first elastic part.

7. The slide locking device according to claim 3 wherein:
said holding means has a setting member that sets the first elastic part in a condition for storing an elastic force larger than the maximum elastic force of the second elastic part, and
wherein the setting member can move in the direction for changing the elastic force of the first elastic part.
